(19) United States
(12) Patent Application Publication
(10) Pub. No.: US 2015/0023760 A1
(43) Pub. Date: Jan. 22, 2015

(54) DRYWALL ANCHOR DEVICE

(71) Applicants: Antonio Bove, III, Naples, FL (US); Vincent Bove, Oviedo, FL (US)

(72) Inventors: Antonio Bove, III, Naples, FL (US); Vincent Bove, Oviedo, FL (US)

(21) Appl. No.: 14/336,729

(22) Filed: Jul. 21, 2014

Related U.S. Application Data
(60) Provisional application No. 61/856,416, filed on Jul. 19, 2013.

(51) Int. Cl. F16B 25/00; F16B 35/00; B23P 19/04; F16B 23/00

(52) U.S. Cl. CPC F16B 25/0042; F16B 23/00; F16B 35/00; B23P 19/04
USPC 411/383; 29/525.02

(57) ABSTRACT

A wall anchoring system is provided. The wall anchoring system includes a metal anchor and a shoulder socket screw. Using the wall anchoring system of the present invention, a wall mounted item may be securely mounted to a drywall. The shoulder socket screw may run through a bore hole of the wall mounted item, and the shoulder socket screw may be screwed into the metal anchor. The metal anchor may be driven into the wall, thereby securing the wall mounted item to the wall.

### CROSS-REFERENCE TO RELATED APPLICATION

This application claims the benefit of priority of U.S. provisional application No. 61/856,416, filed Jul. 19, 2013, the contents of which are herein incorporated by reference.

### BACKGROUND OF THE INVENTION

The present invention relates to a wall anchor device and, more particularly, to an easy to install high weight capacity wall anchor device.

Currently, to quickly install a wall hook, an adhesive strip installation wall hook may be used. However, the adhesive strip wall hooks have a low weight capacity and therefore cannot be used for many desired appliances. To hang a high weight capacity wall hook in drywall one must install a wall molly first. A standard Phillips head screw driver needs to be used for installation, which may slip from the screw or molly causing injury or damage. Therefore, there is currently no easy process to hang a hook that provides a high weight capacity hook. As can be seen, there is a need for a high weight capacity and easy to install wall anchor device.

### SUMMARY OF THE INVENTION

In one aspect of the present invention, a wall anchoring system comprises: a metal anchor comprising a tip portion, and an end portion wherein the metal anchor is threaded with a wide blade coarse thread, wherein the end portion comprises a threaded receiver comprising a fine thread; and a shoulder socket screw comprising a first end and a second end, wherein the first end is threaded with a fine thread formed to mate with the fine threaded receiver, and wherein the second end comprises a drive screw socket.

In another aspect of the present invention, a method of attaching a wall mounted item to a wall comprises: providing a metal anchor comprising a wide blade coarse outer thread and a fine threaded receiver; providing a shoulder socket screw comprising a first end and a second end, wherein the first end is threaded with a fine thread and the second end comprises a drive screw socket; placing the shoulder socket screw through a bore hole in the wall mounted item; screwing the first end of the shoulder socket screw into the fine threaded receiver; placing a screw driver into the drive screw socket; pressing a tip of the metal anchor into the wall; and rotating the screw driver, and thereby drilling the metal anchor into the wall.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is an exploded view of the present invention;

FIG. 3 is a perspective view demonstrating installation of the present invention;

FIG. 4 is a perspective view demonstrating installation of the present invention;

FIG. 5 is a front perspective exploded view of the present invention.

FIG. 6 is a rear perspective exploded view of the present invention.

FIG. 7 is a front perspective view of an anchor and a shoulder socket screw of the present invention;

FIG. 8 is a rear perspective view of an anchor and a shoulder socket screw of the present invention; and

FIG. 9 is a section view of the present invention along line 9-9 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a metal alloy drywall anchor with a hex drive shoulder socket screw to create an anchor bolt. Combining these two components gives a wall mounted item a maximum weight capacity with high torque and balance during installation into any drywall interior wall. In certain embodiments, the metal drywall anchor may have a length of about 20 mm up to about 35 mm. For example, the metal drywall anchor may be 25 mm in length. The hex drive shoulder socket screw may be 3/32 inches up to about 9/64 inches, such as 8/32 inch.

Without the need to measure or mark the hanging point on the wall, hold the device in one hand. With the T-handle tool in the other hand, place the device onto the wall in its desired position by eye or one can use a level for accuracy. Push the device against the wall just enough to puncture the drywall and begin to turn the T-handle tool clockwise while applying forward pressure on the handle to drive the anchor unit completely into the wall within three to four turns.

Once the device is flush against the wall and the anchor/bolts can no longer turn, the user has properly installed the wall hanging device with the hex bolts and can immediately begin use.

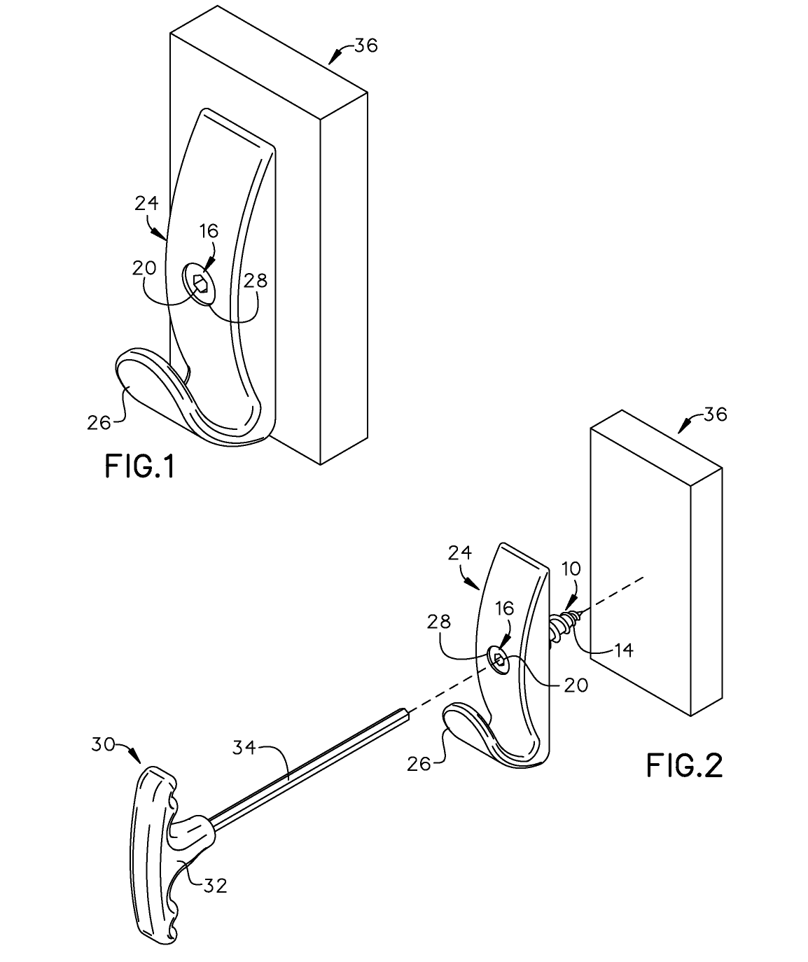

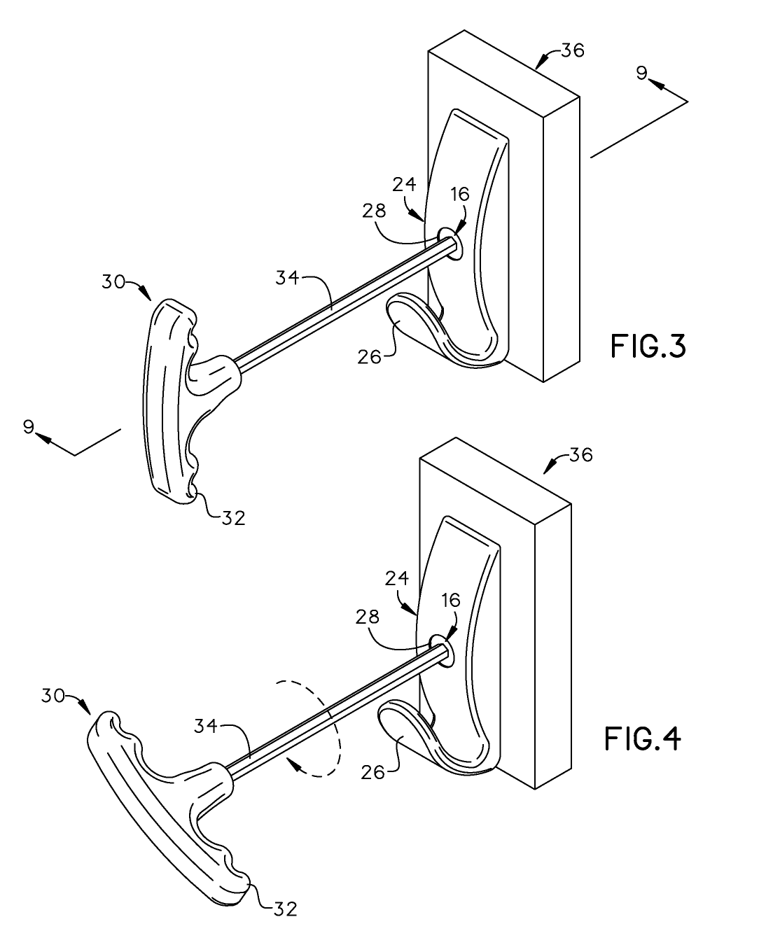

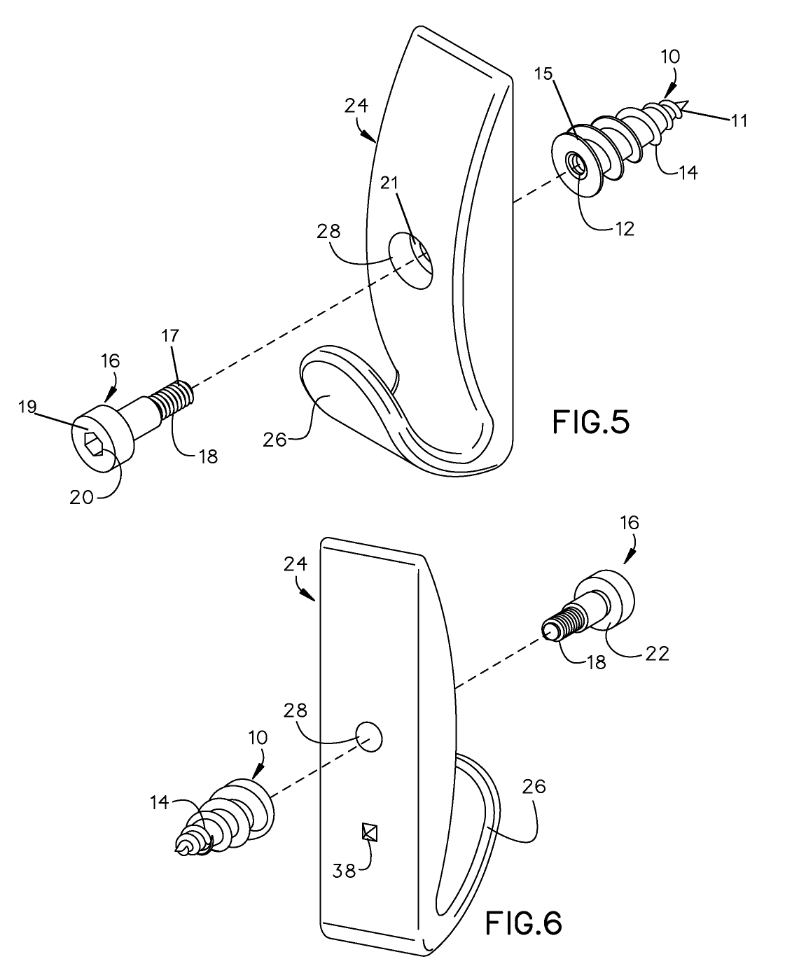

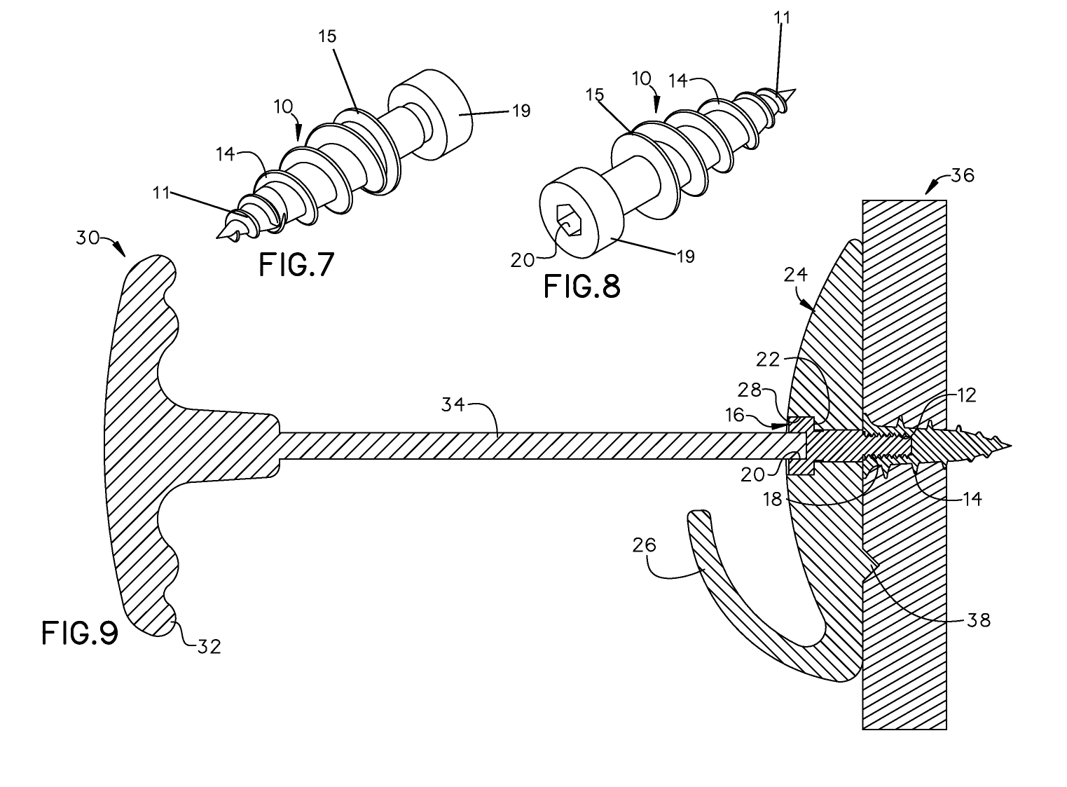

Referring to FIGS. 1 through 9, the present invention includes a wall anchoring system with a metal anchor 10 and a shoulder socket screw 16. Using the wall anchoring system of the present invention, a wall mounted item 24 may be securely mounted to a drywall 36. The shoulder socket screw 16 may run through a bore hole 28 of the wall mounted item 24, and the shoulder socket screw 16 may be screwed into the metal anchor 10. The metal anchor 10 may be driven into the wall 36, thereby securing the wall mounted item 24 to the wall 36.

In certain embodiments, the anchor 10 of the present invention may include a tip portion 11 and an end portion 15. The anchor 10 may have an outer threading that may be a wide blade coarse thread 14. The wide blade coarse thread 14 may be used to drill into the wall 36. The tip portion 11 may be tapered. However, in certain embodiments, the entire metal anchor 10 may taper. The end portion of the metal anchor may include a threaded receiver 12. The threaded receiver 12 may include a fine thread.

The shoulder socket screw 16 may include a first end 17 and a second end 19. A threaded portion 18 is disposed at the first end 17, a body portion is disposed in between the first and second end 17, 19, and a shoulder portion 22 is disposed at the second end 19. The shoulder portion 22 may include a larger diameter than the rest of the shoulder socket screw 16. The threaded portion 18 may include a fine thread and may be formed to mate with the threaded receiver 12, and thereby releasably attach to the threaded receiver 12. The second end 19 may include a drive screw socket 20. A screw driver 30 may be inserted into the drive screw socket 20 to attach the threaded portion 18 to the threaded receiver 12 and drive the anchor 10 into the wall 36.

As mentioned above, the present invention is used to mount a wall mounted item 24 to a wall 36. The wall mounted item 24 may include but is not limited to, hooks 26, racks, hangers, wall racks, wine rack, mop/broom holder, dry erase boards, picture hangers, garage wall hanging applications (e.g. hose hangers, ladder racks, garden tool racks), heavy weight capacity drywall hooks to hang students backpacks, wall hanging coat racks, kitchen pots and pans rack, and the like. As illustrated in the Figures, the wall mounted item 24 may further include a puncture pyramid 38 to further stabilize the wall mounted item 24 against the wall 36.

As mentioned above, the screw driver 30 may fit within the drive screw socket 20 and may be used to mount the anchor 10 to the wall 36. The screw driver 30 may include a handle 32 and a shaft 34. In certain embodiments, the drive screw socket 20 may be a hex screw socket. Therefore, the screw driver 20 may be a hex screw driver. However, the present invention may utilize Phillips or flat head screws, torx drive screws, star drive screws and any other variable drive that is known in the art.

A method of attaching a wall mounted item 24 to a wall 36 may include the following. The shoulder socket screw 16 described above may be placed through the bore hole 28 of the wall mounted item. The threaded portion 18 of the shoulder socket screw 16 may be screwed into the fine threaded receiver 12 of the anchor 10. The screw driver 30 may placed within the drive screw socket 20. The tip of the metal anchor 10 may be pressed into the wall 36. The screw driver 30 may be rotated, and thereby drilling the metal anchor 10 into the wall 36. The anchor 10 may be drilled into the wall 36 so that the shoulder 22 of the shoulder socket screw 16 is firmly pressed against an internal ridge 21 within the bore hole 28.

It should be understood, of course, that the foregoing relates to exemplary embodiments of the invention and that modifications may be made without departing from the spirit and scope of the invention as set forth in the following claims.

What is claimed is:

1. A wall anchoring system comprising:
a metal anchor comprising a tip portion, and an end portion wherein the metal anchor is threaded with a wide blade coarse thread, wherein the end portion comprises a threaded receiver comprising a fine thread; and
a shoulder socket screw comprising a first end and a second end, wherein the first end is threaded with a fine thread formed to mate with the fine threaded receiver, and wherein the second end comprises a drive screw socket.

2. The wall anchoring system of claim 1, wherein the drive screw socket is a hex screw socket.

3. The wall anchoring system of claim 1, wherein the shoulder socket screw comprises a shoulder portion at the second end, wherein the shoulder comprises a larger diameter than the first end.

4. The wall anchoring system of claim 1, wherein at least the tip portion is tapered.

5. The wall anchoring system of claim 1, wherein the metal anchor is tapered from the tip portion to the end portion.

6. The wall anchoring system of claim 1, further comprising a wall mounted item, wherein the wall mounted item is attached in between the metal anchor and the shoulder socket screw.

7. The wall anchoring system of claim 1, wherein the wall mounted item is a wall mounted hanger.

8. A method of attaching a wall mounted item to a wall comprising:
providing a metal anchor comprising a wide blade coarse outer thread and a fine threaded receiver;
providing a shoulder socket screw comprising a first end and a second end, wherein the first end is threaded with a fine thread and the second end comprises a drive screw socket;
placing the shoulder socket screw through a bore hole in the wall mounted item;
screwing the first end of the shoulder socket screw into the fine threaded receiver;
placing a screw driver into the drive screw socket;
pressing a tip of the metal anchor into the wall; and
rotating the screw driver, and thereby drilling the metal anchor into the wall.

9. The method of claim 8, wherein the drive screw socket is a hex screw socket, and wherein the screw driver is a hex screw driver.

10. The method of claim 8, wherein the anchor is drilled into the wall so that the shoulder of the shoulder socket screw is firmly pressed against an internal ridge within the bore hole.
